(19) United States
(12) Patent Application Publication
(10) Pub. No.: US 2003/0093914 A1
(43) Pub. Date: May 22, 2003

(54) Double tip-double sided tape measure

(76) Inventors: Jess E. Croya, Hull, GA (US); Randall G. Payne, Hull, GA (US)

Correspondence Address: Judy Jarecki-Black, Ph.D., J.D., 467 Ware Road, Carnesville, GA, 30521, US

(21) Appl. No.: 09/993,233

(22) Filed: Nov. 16, 2001

(51) Int. Cl. G01B 3/10

(52) U.S. Cl. 33/758

(57) ABSTRACT

The present invention provides a tape measure having a top wall, a bottom wall, a first spaced end wall and a second spaced end wall, with an opening in the first spaced end wall having a double-sided retractable tape extending therefrom; the double-sided retractable tape having a top side and a bottom side and marked identically on both sides with a graduated scale in metric or U.S. units of linear measure; the tape being normally retractably stored in the housing with the proximal end at all times exteriorly accessible of the opening; the proximal end of the tape including a double-tipped terminal end having an upper flange and a lower flange extending simultaneously upwardly and downwardly and positioned substantially perpendicularly to the tape, such that the terminal end can be seated on a lip or shoulder of a workpiece to releaseably retain the free end of the tape, while a remainder of the portion of the tape is played out from the housing.

The present application claims the benefit of priority from U.S. Pat. No. D443, 215 S, issued Jun. 5, 2001.

### FIELD OF THE INVENTION

The present invention relates generally to a measuring device. More specifically, the present invention provides a double-sided retractable tape measure having a top side and a bottom side and marked identically on both sides with a graduated scale in metric or U.S. units of linear measure. The tape measure further includes a double tipped end piece such that the tape measure can be seated in a perpendicular orientation with respect to the tape when either the top side or bottom side is disposed in an upwardly direction.

### BACKGROUND OF THE INVENTION

Conventional tape measures are well known in the construction and carpentry arts as well as being frequently used in minor home repairs. For example, U.S. Pat. No. 5,367,785 to Benarroch discloses a locking and measuring device having a housing within which there is wound a strong, extendable length of material bearing indicia therealong so that it can serve as a measuring tape and having a terminal end along the length of material, which extends from a first opening in the housing and including a locking end zone which is adapted to be inserted into a companionate second opening in the housing where it engages such that the device can also be utilized to lock up various items. However, in Benarroch, the graduated indicia are disposed on only one side of the flexible tape restricting the use of the tape to situations in which the tape side bearing the indicia is disposed in an upwardly direction.

U.S. Pat. No. 5,481,810 to Hastings et al. discloses a combination tape measure and straight edge apparatus which permits the use of a tape measure with a with a substantially flat triangle. However, as taught by Hastings et al, the tape's vertical tab is displaced vertically only in a downwardly direction allowing the tape to be hooked over a board in only one orientation.

Other innovations relating to tape measures include the tape measure disclosed by Cook in U.S. Pat. No. 6,237,243. Cook discloses an improved tape measure comprising a tape having a concave side and a convex side and a case for housing the tape in a coiled retracted configuration within the case. The concave side includes graduations of a first linear scale extending along substantially the full length of the tape, the first linear scale being in metric or U.S. units of linear measure, while the convex side has graduations of a second linear scale different and distinct from the first linear scale and calibrated for a different and distinct use from those of the first linear scale such as an architectural scale or an engineering scale. In addition to having different linear scales on the two sides of the tape measure, the scale on the convex side extends along only a relatively short portion of a length of the tape starting from in close proximity to the free end.

Other innovations developed relating to tape measures include the following U.S. patents: U.S. Pat. Nos. 4,228,594; 4,438,538; 5,735,052 and 6,212,787. More specifically, U.S. Pat. No. 4,228,594 discloses a tape measure combined with a layout tool for locating holes on structural steel. U.S. Pat. No. 4,438,538 discloses a tape measure combined with a chalk line reel. U.S. Pat. No. 5,735,052 discloses a tape measure including a pen tip opening disposed with intersecting cross lines which outward extend to mark a right angle cutout and further formed with a circle center hole which has the functions of drafting a circle, measuring whether an article is vertical and measuring the horizontal distance between two points on different levels. U.S. Pat. No. 6,212,787 discloses a tape measure having a guide at the end of the tape that seats a marking instrument in a perpendicular orientation with respect to the tape and/or a pencil sharpening device incorporated into the housing of the tape measure.

Thus, while the foregoing body of prior art indicates it to be well known to use tape measures in combination with other devices and having a graduated linear scale on one side of the tape measure, the prior art described above does not teach or suggest a tape measure having a graduated linear scale on both sides of the tape and further including a double-tipped terminal end displaced vertically simultaneously in an upwardly and downwardly direction allowing the tape to be hooked over the object to be measured in either orientation.

### SUMMARY OF THE INVENTION

Briefly described, the present invention relates to a tape measuring device. Included in the present invention is a housing within which there is wound a double-sided retractable tape measure having a concave side and a convex side and marked identically on both sides with a graduated scale in metric or U.S. units of linear measure. The tape measure further includes an attachment clip, by which the tape measure may be attached to a belt or the like for convenient storage when the tape measure is not in use, and a double tipped end piece such that the tape measure can be seated in a perpendicular orientation with respect to the tape when either the top side or bottom side is disposed in an upwardly direction.

In one embodiment of the present invention, the tape measure further includes a locking button slidably attached to the housing to selectively prevent the retractable tape from moving with respect to the opening in the housing from which the tape retractably extrudes.

These and other objects, features and advantages of the present invention will become more apparent upon review of the detailed description set forth below when taken in conjunction with the accompanying figures, which are briefly described as follows.

### BRIEF DESCRIPTION OF THE FIGURES

A full and enabling disclosure of the present invention, including the best mode thereof, to one of ordinary skill in the art, is set forth more particularly in the remainder of the specification, including reference to the accompanying figures, wherein:

FIG. 1 is a schematic perspective view of a tape measure according to one embodiment of the present invention illustrating an attachment clip thereof and showing the tape in an extended position;

FIG. 2 schematically illustrates a tape measure according to one embodiment of the present invention showing the tape fully retracted into the housing;

FIG. 3 is a top assembled view showing the scales marked on the top side of the tape according to one embodiment of the present invention; and

FIG. 4 illustrates a bottom assembled view of the tape measure showing the scales marked on the bottom side of the tape according to one embodiment of the present invention.

### DETAILED DESCRIPTION OF THE PREFERRED EMBODIMENT

Other objects, features and aspects of the present invention are disclosed in, or are obvious from, the following Detailed Description. It is to be understood by one of ordinary skill in the art that the present discussion is a description of exemplary embodiments only and is not intended as limiting the broader aspects of the present invention, which broader aspects are embodied in the exemplary construction. In fact, it will be apparent to those skilled in the art that various modifications and variations can be made in the present invention without departing from the scope or spirit of the invention. For instance, features illustrated or described as part of one embodiment can be used in another embodiment to yield a still further embodiment. It is intended that the present invention cover such modifications and variations as come within the scope of the appended claims and their equivalents.

The present invention provides a double-sided retractable tape measure having a top side and a bottom and marked identically on both sides with a graduated scale in metric or U.S. units of linear measure. The tape measure further includes a double-tipped end piece such that the tape measure can be seated in a perpendicular orientation with respect to the tape when either the top side or bottom side is disposed in an upwardly direction.

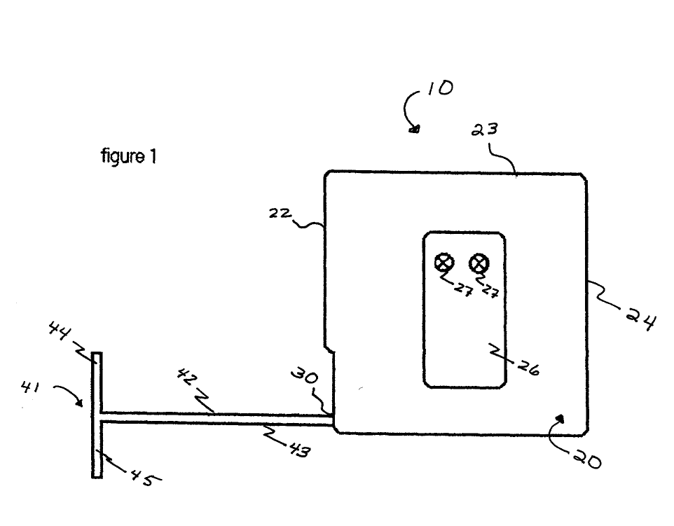

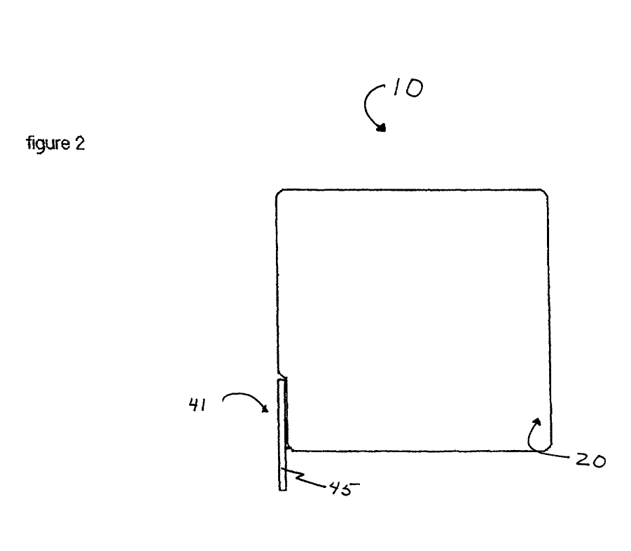

Referring now to FIGS. 1-4, a tape measure according to the present invention, generally indicated as 10, is illustrated. The tape measure 10 includes a housing 20 with a first spaced end wall 22, a top wall 23, a second space end wall 24 and a bottom wall 25. Specifically, the housing 20 can be formed of a variety of materials including, but not limited to, a plastic, metal, a composite or laminate in any manner generally known in the art, and is substantially small and compact such that it can be easily carried or transported much like a standard tape measure casing. In one embodiment of a tape measure according to the present invention, housing 20 further includes attachment clip 26 fixably attached to housing 20 with rivets 27.

Positioned in the first spaced end wall 22 of the housing 20 is a first opening 30. This first opening 30 is positioned to provide access to an interior of the housing 20 and is adapted to provide slidable access to tape 40. Tape 40, having a distal end and a proximal end, comprises an extendable length of substantially strong and durable, yet bendable, material having top side 42 and bottom side 43. Tape 40 further comprises, on its proximal end, double-tipped terminal end 41, substantially perpendicular to a longitudinal axis of tape 40 to prevent tape 40 from passing through opening 30 into housing 20 and, on its distal end and oppositely disposed to terminal end 41, an attachment end by which tape 40 is fixedly secured within housing 20 such that the attachment end will always be maintained within the housing 20, thereby anchoring the length of tape 40 so that it will normally retract into the housing 20. Terminal end 41 further comprises upper flange 44 and lower flange 45, which are oppositely disposed and generally perpendicular to tape 40, for engaging a work piece during measurements. Terminal end 41 may be integrally incorporated with the proximal end of tape 40 or attached thereto by means of conventional fasteners, such as rivets, or with an adhesive, bonding or welding. It is an important aspect of the present invention, however, that terminal end 41, adapted to protrude through the first opening 30 and be exteriorly accessible of the first opening 30 at all times, comprises a double tipped terminal end piece having upper flange 44 and lower flange 45, substantially equal in length, extending simultaneously upwardly and downwardly from tape 40 and positioned substantially perpendicular to tape 40. Thus, tape 40 can be seated on a lip or shoulder of a workpiece to releaseably retain the free end of tape 40, while a remainder of the portion of the tape is played out from housing 20. Accordingly, terminal end 41 has sufficient rigidity that it can be placed over an edge of a workpiece, such as a board, a plywood sheet, a section of plasterboard or the like, to retain the end of tape 40 aligned with the edge of the workpiece when either top side 42 or bottom side 43 is disposed in an upwardly direction, while the tape is extended by a user holding the housing of the tape. In one embodiment of the present invention, upper flange 44 extends upwardly from terminal end 41 for approximately ½ inch while lower flange 45, substantially equal in length to upper flange 44, extends ½ inch in a downwardly direction from the terminal end.

Tape 40 is stored in a coiled configuration within housing 20 and is retractable to and from housing 20 through opening 30. In addition, housing 20 includes a retraction mechanism for selectively retracting the tape into the housing, for example, the far end of tape 40 may be connected to a conventional spring mechanism in the interior of the housing that automatically retracts the tape inside the housing. The tape measure may also include a conventional locking mechanism for disposing a length of the tape in an extended position and preventing the tape from automatically retracting inside the housing Conventionally, such locking mechanisms may be activated by a user via some type of button located at the bottom wall 25 of the housing, or on the second spaced end wall 24 opposed to opening 30. One example of a locking mechanism suitable for use in a tape measure made according to the present invention is disclosed by Holevas et al., in U.S. Pat. No. 5,435,074 (the contents of which is incorporated herein by reference in its entirety).

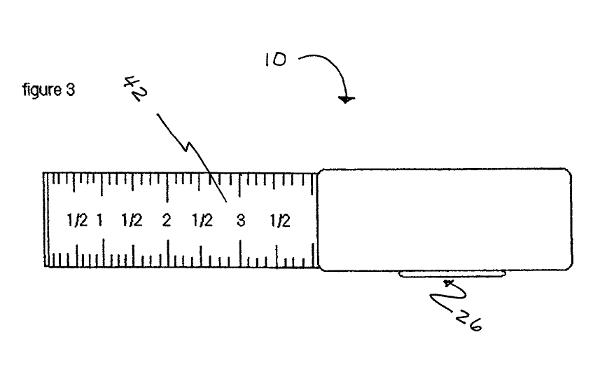

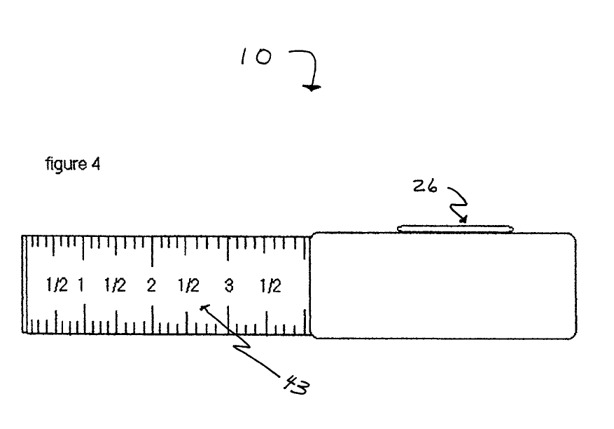

Tape 40 is typically made of metal but may be formed of a variety of materials including, but not limited to, metal, plastic, composites or laminates, and the like and, optionally, includes reinforcing means to substantially increase the strength thereof and substantially resist tearing or cutting while remaining generally flexible, yet self-supporting in a sufficiently limited distance of material. The tape may be formed with a planar or curvilinear profile or cross-section having a convex upper side and a concave bottom side. Referring now to FIGS. 3 and 4, top side 42 and bottom side 43 of tape 40, respectively, are illustrated. Both sides are identically marked with measurement markings at predetermined increments, which may be of either U.S. or metric scale or any other convenient scale of linear measurement, for example, in ⅛ or 1/16 inch increments, and which extend along substantially the entire length of tape 40. An important aspect of the present invention is that the separate scales on top side 42 and bottom side 43 are identical scales and positioned identically with each scale beginning adjacent to or in proximity of terminal end 41. For example, in one embodiment of a tape made according to the present invention, the scale begins about ½ inch from terminal end 41 of tape 40.

FIGS. 3 and 4 illustrate identical measurement scales, representing U.S. linear measurements and having ⅛ inch gradations, on top side 42 and bottom side 43, respectively, of tape 40. However, as will be obviously to one of skill in the art, tape 40 may include any other useful, convenient scale in U.S. or metric terms as desired. Likewise, the overall length of tape 40 may be made in varying s desired for a particular use. For example, in one embodiment of a tape measure made according to the present invention, the overall length of tape 40 is 25 feet.

While the invention has been described with reference to specific methods and embodiments, such description is for illustrative purposes only. The words used are words of description rather than of limitation. It is to be understood that changes and variations may be made by those of ordinary skill in the art without departing from the spirit or scope of the present invention, which is set forth in the following claims.

What is claimed is:

1. A tape measure comprising:
a housing having a top wall and a bottom wall separated by a first spaced end wall and a second spaced end wall;
an opening disposed in said first spaced end wall;
a tape having a top side and a bottom side, said tape comprising an extendable length of substantially strong and durable, yet bendable material retractably disposed within said housing, said tape including an attachment end and a terminal end;
said tape being normally, retractably stored in said housing with said attachment end fixedly secured within said housing and said terminal end protruding through said opening and being at all times exteriorly accessible of said opening;
said terminal end having an upper flange and a lower flange, said upper flange extending upwardly and said lower flange extending downwardly from said tape and positioned substantially perpendicular to said tape, and
said top side and said bottom side having identical graduated indicia extending along substantially the entire length of said tape, said indicia comprising a measuring scale.

2. A tape measure according to claim 1, further comprising an attachment clip.

3. A tape measure according to claim 1, wherein said graduated indicia are marked in 1/16 inch increments.

4. A tape measure according to claim 1, wherein the top side and bottom side of said tape are planar.

5. A tape measure according to claim 1, wherein the top side and bottom side of said tape are arcuate in cross section.
